(19) United States
(12) Patent Application Publication
(10) Pub. No.: US 2017/0255722 A1
(43) Pub. Date: Sep. 7, 2017

(54) GLOBALLY UNIVERSAL KEY FACTOR PRESET ARRAY PLATFORM FOR DYNAMIC FORECAST ANALYSIS OF BIOLOGICAL POPULATIONS

(71) Applicant: Hunan Agricultural University, Hunan (CN)

(72) Inventors: Lizhang Wen, Hunan (CN); Yafeng Wen, Hunan (CN); Yichun Wen, Hunan (CN); Zhongxia Yang, Hunan (CN); Weiwen Tan, Hunan (CN); Yongqiang Han, Hunan (CN)

(73) Assignee: Hunan Agricultural University, Hunan (CN)

(21) Appl. No.: 15/528,519

(22) PCT Filed: May 14, 2015
(86) PCT No.: PCT/CN2015/000329

§ 371 Date: May 22, 2017

(30) Foreign Application Priority Data
Feb. 4, 2015 (CN) 201510057839.3

(51) Int. Cl. G06F 17/50

(52) U.S. Cl. CPC G06F 17/5009

(57) ABSTRACT

The present invention discloses a globally universal key factor preset array platform for dynamic forecast analysis of biological populations, which can be used to preset massive arrays of standard environmental factors; and through the Internet user's registration system, global users for biological population dynamic forecast can instantly select the contents suitable for their own country or local region to construct an accurate statistically forecast model for specific area and specific biological population dynamics, so as to make an accurate quantitative forecast of biological population dynamics in the future. Each preset data is co-located by a row variable coordinate and a column variable coordinate. Each located individual data can not be interchanged up and down or to and fro, the row variable coordinate is time coordinate and the column variable coordinate is space coordinate. This invention effectively resolves the existing problems in the current life population forecasting such as incapability to construct an effective forecast models or poor forecast effect or narrow application scope of the constructed model for many important biotic populations due to it is difficulty to timely access to adequate and effective environmental information amount for users.

### FIELD OF THE INVENTION

The present invention relates to a field of dynamic forecast of natural life populations, and in particular, relates to a globally universal key factor preset array platform for dynamic forecast analysis of biological populations.

### BACKGROUND OF THE INVENTION

There are 3 major problems in the current life population forecasting:

(1) Outlier of predicted values causes poor forecast effect. In the past, when performing forecasting analysis of biological populations, some predicted values are far from the measured values (i.e. Outlier of predicted values), which results in poor forecast effect.

(2) Lack of environmental information amount, which makes it impossible to construct effective models. In the past, people tend to pay attention to the correlation of things in the same period and nearby, but ignore the correlation of things in the past and far away; therefore, it can result in the available environmental information difficultly meet the information amount required by the forecast models.

(3) Often single factor analysis or less factor analysis is performed, which results in time lag of the constructed models. In the past, single factor or a few factors are used to screen and construct models due to unable to find more environmental factors, thus ignore the more and higher relevant influencing factors, resulting in serious one-sidedness of the obtained forecast models. So that even if the simulation effect is better, because of the uncertainty of the forecast factor itself (for example, the influence is larger due to irregularity of other unknown factors), its forecast effect is not ideal for the predicted objects.

### SUMMARY OF THE INVENTION

The object of the embodiment of the invention is to provide a globally universal key factor preset array platform for dynamic forecast analysis of biological populations, which aims to resolve the problems existing in the life population forecasting, such as outliers of predicted values that results in poor forecast effect, and inadequate environmental information that makes impossible to construct an effective model; single factor or fewer factor analysis which is frequently made that results in time lag of the constructed models.

The invention is achieved through the following technical solution:

A globally universal key factor preset array platform for dynamic forecast analysis of biological populations, wherein each data is co-located by a row variable coordinate and a column variable coordinate, and each located individual datum can not be interchanged up and down or to and fro, the row variable coordinate is time coordinate and the column variable coordinate is space coordinate.

Further, the up-down sequence of the row variable coordinate is represented by a natural number or any one interval of time among year, quarter, month, ten-day, week or day, and the up-down sequence can not be interchanged up and down or to and fro.

Further, the name of column variable coordinate is represented by a natural number, an English letter, a combination of natural number and English letter, or original factor name of the column variable, and the left-right sequence of the column variable can be interchanged in whole column with the name, but the position of a single data cannot be interchanged.

Further, the globally universal key factor preset array platform for dynamic forecast analysis of biological populations comprises a preset factor array and a user factor array; in the preset factor array, except the time sequence variable representing time coordinate, the sum and mean of this column array of variables in other each of column is 0, and both the standard deviation and variance are 1, the sum, mean, standard deviation and variance of the array in each column variable in the user factor array are not restricted by the numerical size and range, but determined by the actual valid array input by users.

Further, the number of rows of a row variable of the preset factor array in the globally universal key factor preset array platform for dynamic forecast analysis of biological populations is greater than or equal to 50 and less than or equal to w, the number of columns of a column variable of the preset factor array is greater than or equal to 50 and less than or equal to co, each data in the preset factor array and user factor array are not restricted by the numerical size, positive or negative number or signs.

Further, a dependent variable of user factor array in the globally universal key factor preset array platform for dynamic forecast analysis of biological populations is a forecasting object, the number of rows of the dependent variable is greater than or equal to 11, the number of columns is greater than or equal to 1; when the independent variable of user factor array is user-provided forecast factor, the number of rows of the independent is greater than or equal to 11, and the number of columns is greater than or equal to 0, when the number of columns is 0, it indicates that users do not provide user-provided forecast factor.

Further, the globally universal key factor preset array platform for dynamic forecast analysis of biological populations is integrally fixed, integrally publicly spread, integrally publicly used and integrally or partially updated through all modern electronic communication equipment, Internet media and all mobile and non-mobile electronic carriers.

Further, the globally universal key factor preset array platform for dynamic forecast analysis of biological populations is integrally installed in any electronic connected network platform, and integrally installed in all mathematical statistic analysis software, geographic information software, navigation software for operation and application.

Further, the globally universal key factor preset array platform for dynamic forecast analysis of biological populations can be compiled into a separate operating system, produced into a separate hardware chip and mounted to all mobile and non-mobile electron carriers for fixing, public communication, public use, and updating in whole or in part, or made to wholly independent monomer or complex electronic devices that are dedicated to forecasting for spreading.

Further, the globally universal key factor preset array platform for dynamic forecast analysis of biological populations can be compiled into independent electronic chips and produced into electronic equipment by cooperating with other similar industries technically.

Further, the globally universal key factor preset array platform for dynamic forecast analysis of biological populations comprises a plurality of time-sharing subsystems, including F0 subsystem, F1 subsystem, F2 subsystem, . . . , Fn subsystem, and the serial number of each subsystem in the many subsystem represents the time stair serial number of the same serial number.

Further, for the globally universal key factor preset array platform for dynamic forecast analysis of biological populations, through the Internet user's registration system, global users for biological population dynamic forecast in various countries of the world can instantly select the contents suitable for their own country or local region to construct accurate statistical forecast model for specific area and specific biological population dynamics, so as to make an accurate quantitative forecast of biological population dynamics in the future.

When performing forecasting with the invention, users usually have two groups or more groups effective forecast models for options. Therefore, they can observe the case which is corresponded to the maximum χ² value in the fit results of the predicted value and the observation values of different models through χ² test in the process of selecting the optimal equation; and if the maximum χ² value in the fit results in many groups of models corresponds to the same observation result case, it can be judged that the outlier is the observation's mistake, and it can be ruled out to re-construct a new model; and if outliers appear in an individual models in the many of models, then it can be judged that the outlier is the model's mistake, and another model should be selected.

When the present invention is applied to forecast, the preset factor array can provide enough environmental information which can not be obtained by users themselves within a short time, which can nearly completely satisfy users' requirements for forecasting any known natural life populations; and at the same time, users can add together their known environmental information to study.

When the present invention is applied to forecast, the preset factor array has collected most conventional key factors and real-time data which relate to the life survival and death and has universal applicability at the existing stage over the world, and provided a platform entry for users to select the contents suitable for specific country or specific region, provided great conveniences for users to comparison and analysis the multiple forecast models in different countries or different regions which are constructed for the same predicted objects, so that greatly reduces the risks of one-sided conclusions obtained from single factor or less factor analysis in local regions, and thus, it gives a guarantee for increasing the accuracy of the forecast results.

### BRIEF DESCRIPTION OF THE DRAWINGS

FIG. 1 is a workflow diagram of a globally universal key factor preset array platform for dynamic forecast analysis of biological populations according to an embodiment of the invention

### DETAILED DESCRIPTION OF THE EMBODIMENTS

In order to make the object, technical solution and advantages of the invention much clearer, the invention is further described in combination with embodiments. It should be understood that, the specific embodiments herein are only used for explaining rather than limiting the invention.

The working principle of the invention is further described in combination with drawings and specific embodiments.

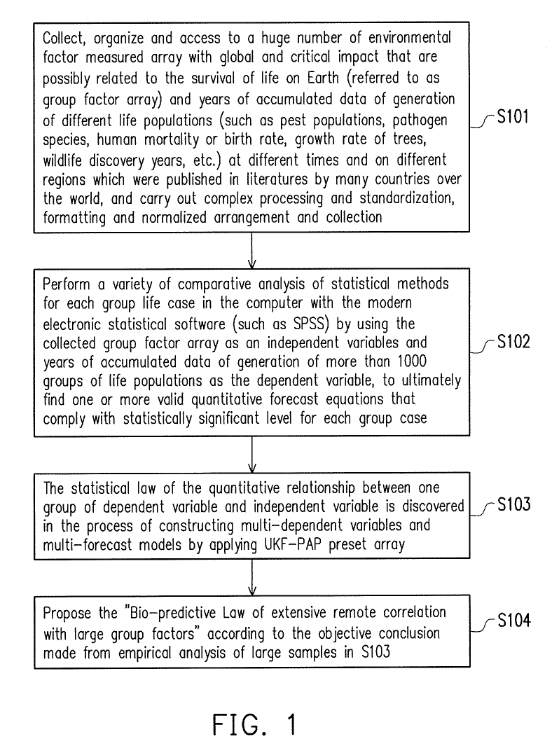

As shown in FIG. 1, the globally universal key factor preset array platform for dynamic forecast analysis of biological populations in the embodiment of the invention comprises the following steps:

S101: collect, organize and access to a huge number of environmental factor measured array with global and critical impact that are possibly related to the life survival and death on Earth (referred to as group factor array) and years of accumulated data of generation of different life populations (such as pest populations, pathogen species, human mortality or birth rate, growth rate of trees, wildlife annual discovery number, etc.) at different times and on different regions which were published in literatures by many countries over the world, and carry out complex processing and standardizing, formatting and normalizing arrangement and collection.

S102: Perform A variety of comparative analysis of statistical methods for each group life case in the computer with the modern electronic statistical software (such as SPSS) by using the collected group factor array as an independent variables and years of accumulated data of generation of more than 1000 groups of life populations as the dependent variable, to ultimately find one or more valid quantitative forecast equations that comply with statistically significant level for each group case; (here it is proposed that, test the reliability of each forecast equation according to the test standard of statistics regression equation fitness, and the standard is: all simultaneously meet the significant level of Fisher (Fisher Ronald Aylmer, 1890-1962) p≦0.05, the maximum value of the multicollinearity variance inflation factor VIE (the variance inflation factor) ≦5˜10 and K·Pearson (Karl Pearson, 1857-1936) p (χ²)≧0.05, it is identified as a valid forecast equation), and the predicated values and observed values of many cases meet the completely fitting degree.

S103: The statistical regularity of the quantitative relationship between one group of dependent variable and independent variable is discovered in the process of constructing multi-dependent variables and multi-forecast models by applying UKF-PAP preset array, namely: 1.when there are more selected independent variables, there are more valid forecast equations that can meet the requirements of 3 significant levels (ie p≦0.05, VIF≦5˜10, p (χ²)≧0.05); 2. When the number of independent variables is increased sufficiently large, for all preconcert over 1,000 dependent variables (wherein including human mortality or birth rates in many countries and regions, the prevalence of the human diseases, the annual incidence of crop pests and diseases, the annual occurrence number of a variety of wildlife, the annual growth of part-perennial arborous plants, etc.), the valid forecast equations that can simultaneously meet the 3 significant levels are found; 3. When there is more independent variable factors, the fitting degree of the best forecast equation obtained for each dependent variable is higher, for example, the predicted value and measured values in many cases have reached completely fitting degree.

S104: Propose the “Bio-predictive Law of extensive remote correlation with large group factors” according to the objective conclusion made from empirical analysis of large samples in S103, namely: for any life population within the finite range, there always be another one or more or its combination of things (including biological and non-biological) which change simultaneously in quantity similar to a certain stable proportional relationship of the life population in the near or distant natural world. Thus, when people propose to predict or explain the quantity change process of a certain more complex life populations by using another change process of things which is more easily known beforehand, they can increase the quantity of the thing whose change process is known to large enough, then one or more statistical models composed by the combination of one or more things can be found with a stable high probability, to accurately forecast the quantity change processes of the complex life populations. This finding provides a scientific theoretical basis for the scientificness and feasibility of “globally universal key factor preset array platform for dynamic forecast analysis of biological populations (UKF-PAP)”.

Table 1 shows the frame diagram of globally universal key factor preset array platform for dynamic forecast analysis of biological populations;

| | | | | User input array | | | | | | | | | | | | | |
|---|---|---|---|---|---|---|---|---|---|---|---|---|---|---|---|---|---|
| | | | | area: ( only for | | | | System preset array area: examples of sequences of globally universal key factor preset array | | | | | | | | | |
| | | | | displaying format) | | | | platform for dynamic forecast analysis of biological populations( oily for displaying format) | | | | | | | | | |
| No. | Year | Mouth | Day | y1 | y2 | . . . | yn | X1 | X2 | X3 | . . . | X100 | . . . | Xn | . . . | . . . | X∞ |
| 1. | 1955 | 1 | 1 | | | | | −0.70 | −0.72 | −0.98 | −0.75 | −0.57 | 0.72 | −1.14 | −0.25 | −0.42 | −0.50 |
| 2. | 1955 | 1 | 2 | | | | | −0.57 | −0.70 | −0.62 | 0.51 | −0.56 | −0.03 | −0.67 | −0.81 | 5.20 | −0.93 |
| 3. | 1955 | 1 | 3 | | | | | 1.20 | 1.04 | −0.79 | −0.74 | 0.18 | 1.48 | −0.38 | −0.53 | −0.32 | −0.51 |
| 4. | . . . | . . . | . . . | | | | | 0.01 | −0.46 | −0.62 | 1.98 | −0.55 | −0.52 | −0.08 | −0.75 | −0.47 | −0.06 |
| 5. | 1955 | 1 | 29 | | | | | −0.77 | −0.72 | −0.87 | −0.70 | 0.19 | −0.55 | −1.10 | −0.45 | −0.25 | −0.22 |
| 6. | 1955 | 1 | 30 | | | | | 2.87 | −0.71 | 0.41 | 0.81 | 2.29 | −0.55 | 0.33 | 1.96 | −0.51 | −0.66 |
| 7. | 1955 | 1 | 31 | | | | | −0.78 | −0.65 | −0.94 | −0.18 | −0.52 | 0.06 | −0.99 | −0.75 | −0.47 | −0.93 |
| 8. | 1955 | 2 | 1 | | | | | −0.77 | −0.52 | −0.21 | −0.74 | 2.85 | −0.78 | −0.54 | −0.76 | 0.71 | −0.86 |
| 9. | 1955 | 2 | 2 | | | | | 0.15 | 1.20 | 0.25 | −0.46 | −0.45 | 0.04 | −1.07 | −0.02 | 1.00 | −0.86 |
| 10. | 1955 | 2 | 3 | | | | | −0.67 | 0.04 | 0.71 | −0.67 | −0.55 | 0.93 | −1.05 | −0.63 | −0.32 | −0.35 |
| 11. | . . . | . . . | . . . | | | | | −0.45 | −0.72 | −0.88 | −0.38 | −0.41 | 0.62 | 0.95 | −0.46 | −0.29 | 1.73 |
| 12. | 1955 | 2 | 27 | | | | | 1.04 | 2.83 | 1.35 | 1.99 | −0.57 | −0.26 | 1.28 | 1.67 | −0.11 | −0.42 |
| 13. | 1955 | 2 | 28 | | | | | −0.67 | −0.72 | −0.71 | −0.67 | −0.55 | −0.78 | −1.05 | −0.63 | −0.32 | −0.35 |
| 14. | 1955 | 3 | 1 | | | | | −0.45 | −0.72 | −0.01 | −0.69 | 0.16 | −0.65 | 0.95 | −0.46 | −0.29 | 1.73 |
| 15. | 1955 | 3 | 2 | | | | | 1.04 | 0.18 | −0.84 | 0.04 | 0.33 | −0.64 | 1.28 | 1.67 | −0.11 | −0.42 |
| 16. | . . . | . . . | . . . | | | | | −0.67 | −0.62 | −0.81 | −0.56 | −0.45 | 0.35 | −1.05 | −0.63 | −0.32 | −0.35 |
| 17. | 1955 | 11 | 1 | | | | | −0.45 | −0.41 | 2.33 | −0.40 | −0.44 | 4.47 | 0.95 | −0.46 | −0.29 | 1.73 |
| 18. | 1955 | 11 | 2 | | | | | 1.04 | 1.04 | 2.85 | 1.71 | −0.33 | 0.21 | 1.28 | 1.67 | −0.11 | −0.42 |
| 19. | 1955 | . . . | . . . | | | | | 2.87 | −0.71 | 0.41 | 0.81 | 2.29 | −0.55 | 0.33 | 1.96 | −0.51 | −0.66 |
| 20. | . . . | 11 | 29 | | | | | −0.78 | −0.65 | −0.94 | −0.18 | −0.52 | 0.06 | −0.99 | −0.75 | −0.47 | −0.93 |
| 21. | . . . | 11 | 30 | | | | | −0.77 | −0.52 | −0.21 | −0.74 | 2.85 | −0.78 | −0.54 | −0.76 | 0.71 | −0.86 |
| 22. | 1955 | 12 | 1 | | | | | 0.15 | 1.20 | 0.25 | −0.46 | −0.45 | 0.04 | −1.07 | −0.02 | 1.00 | −0.86 |
| 23. | 1955 | 12 | 2 | | | | | −0.67 | 0.04 | 0.71 | −0.67 | −0.55 | 0.93 | −1.05 | −0.63 | −0.32 | −0.35 |
| 24. | . . . | . . . | . . . | | | | | −0.45 | −0.72 | −0.88 | −0.38 | −0.41 | 0.62 | 0.95 | −0.46 | −0.29 | 1.73 |
| 25. | 1955 | 12 | 30 | | | | | 1.04 | 2.83 | 1.35 | 1.99 | −0.57 | −0.26 | 1.28 | 1.67 | −0.11 | −0.42 |
| 26. | 1955 | 12 | 31 | | | | | −0.67 | −0.72 | −0.71 | −0.67 | −0.55 | −0.78 | −1.05 | −0.63 | −0.32 | −0.35 |
| 27. | 1956 | 1 | 1 | | | | | −0.45 | −0.72 | −0.01 | −0.69 | 0.16 | −0.65 | 0.95 | −0.46 | −0.29 | 1.73 |
| 28. | 1956 | 1 | 2 | | | | | −0.45 | −0.41 | −0.88 | −0.38 | −0.41 | 0.62 | 0.95 | −0.46 | −0.29 | 1.73 |
| 29. | . . . | . . . | . . . | | | | | 1.04 | 1.04 | 1.35 | 1.99 | −0.57 | −0.26 | 1.28 | 1.67 | −0.11 | −0.42 |
| 30. | 1956 | 12 | 31 | | | | | −0.67 | −0.62 | −0.71 | −0.67 | −0.55 | −0.78 | −1.05 | −0.63 | −0.32 | −0.35 |
| 31. | . . . | . . . | . . . | | | | | −0.45 | −0.41 | −0.01 | −0.69 | 0.16 | −0.65 | 0.95 | −0.46 | −0.29 | 1.73 |
| 32. | 2015 | 1 | 1 | | | | | 1.04 | −0.41 | 1.35 | 1.99 | −0.57 | −0.26 | 1.28 | 1.67 | −0.11 | −0.42 |
| 33. | . . . | . . . | . . . | | | | | −0.67 | 1.04 | −0.71 | −0.67 | −0.55 | −0.78 | −1.05 | −0.63 | −0.32 | −0.35 |
| 34. | 2015 | 12 | 31 | | | | | −0.45 | 1.04 | −0.01 | −0.69 | 0.16 | −0.65 | 0.95 | −0.46 | −0.29 | 1.73 |
| 35. | . . . | . . . | . . . | | | | | . . . | . . . | . . . | . . . | . . . | . . . | . . . | . . . | . . . | . . . |
| . . . | . . . | . . . | | | | | | . . . | . . . | . . . | . . . | . . . | . . . | . . . | . . . | . . . | . . . |
| ∞ | . . . | . . . | | | | | | . . . | . . . | . . . | . . . | . . . | . . . | . . . | . . . | . . . | . . . |

The invention is achieved as follows:

A globally universal key factor preset array platform for dynamic forecast analysis of biological populations, wherein each data is co-located by a row variable coordinate and a column variable coordinate, and each located individual datum can not be interchanged up and down or to and fro, the row variable coordinate is time coordinate and the column variable coordinate is space coordinate.

Further, the up-down sequence of the row variable coordinate is represented by a natural number or any one interval of time among year, quarter, month, ten-day, week or day (e.g. year 1998, 1999, 2014 . . . ; January, February . . . ; day 1, day 2 . . . ; June 1, 205 . . . ), and the up-down sequence can not be interchanged up and down or to and fro.

Further, the name of column variable coordinate is represented by a natural number (e.g. 1, 2, 3, . . . ) or an English letter (A, B, C, . . . , a, b, c . . . ) or combination of natural number and English letter (e.g. A0, 0A, b1, 1b, A02 . . . ) or original factor name of the column variable (e.g. temperature, sunspot number, . . . ) so on, and the left-right sequence of the column variable can be interchanged in whole column with the name, but the position of a single data cannot be interchanged.

Further, the globally universal key factor preset array platform for dynamic forecast analysis of biological populations comprises a preset factor array and a user factor array; in the preset factor array, except of the time sequence variable representing time coordinate, the sum and mean of this column array of variables in other each of column is 0, and both the standard deviation and variance are 1, the sum, mean, standard deviation and variance of this column array in each column variable in the user factor array are not restricted by the numerical size and range, but determined by the actual valid array input by users.

Further, the row number of a row variable of the preset factor array in the globally universal key factor preset array platform for dynamic forecast analysis of biological populations is greater than or equal to 50 and less than or equal to ∞, and if the row number of a row variable is set N_{row}, then 50≦N_{row}≦∞; the column number of a column variable of the preset factor array is greater than or equal to 50 (column) and less than or equal to ∞, and if the row number of the column variable is set N_{col}, then 50≦N_{col}≦∞. Each data in the preset factor array and user factor array are not restricted by the numerical size, positive or negative number or signs.

Further, a dependent variable of user factor array in the globally universal key factor preset array platform for dynamic forecast analysis of biological populations is a forecasting object, the number of rows of the dependent variable is greater than or equal to 11, the number of columns is greater than or equal to 1; when the independent variable of user factor array is user-provided forecast factor, the number of rows of the independent is greater than or equal to 11, and the number of columns is greater than or equal to 0, when the number of columns is 0, it indicates that users do not provide user-provided forecast factor.

Further, the globally universal key factor preset array platform for dynamic forecast analysis of biological populations can be integrally fixed, integrally publicly spread, integrally publicly used and integrally or partially updated through all modern electronic communication equipment(such as mobile phones, navigation systems, etc.), Internet media (such as Web pages, databases, e-mail, online video, online chat rooms, etc.) and all mobile and non-mobile electronic carriers (such as various forms of electronic readers, electronic calculators, CD-ROM, electronic pen, U disk, computer, etc.).

Further, the globally universal key factor preset array platform for dynamic forecast analysis of biological populations can be integrally installed in any electronic connected network platform, and integrally installed in all mathematical statistic analysis software, such as SPSS, SAS, geographic information software, such as GIS, navigation software such as GPS that are operated in electronic equipment (such as computers, mobile phones, network databases, etc.) for operation and application.

Further, the globally universal key factor preset array platform for dynamic forecast analysis of biological populations can be compiled into a separate operating system, produced into a separate hardware chip and mounted to all mobile and non-mobile electron carriers (such as various forms of electronic readers, electronic calculators, CD-ROM, electronic pen, U disk, computer, etc.) for fixing, public communication, public use, and updating in whole or in part, or made to wholly independent monomer or complex electronic devices that are dedicated to forecasting for spreading.

Further, the globally universal key factor preset array platform for dynamic forecast analysis of biological populations can be compiled into independent electronic chips and produced into electronic equipment by cooperating with other similar industries technically, for example, specialized miniature electronic equipment for information collection and processing of crop pest forecast and control is suitable for relevant administrative departments of agriculture and individual producers; and it can be produced to specialized miniature electronic equipment for human disease prevention and epidemic prediction and for wildlife protection and investigation, etc. which is suitable for relevant department and individual.

Further, the globally universal key factor preset array platform for dynamic forecast analysis of biological populations comprises a plurality of time-sharing subsystems, including F0 subsystem, F1 subsystem, F2 subsystem, . . . , Fn subsystem (1≦n≦∞), and the serial number of each subsystem represents the time stair serial number; for example, F0 subsystem indicates that the subsystem array is suitable for constructing biomass dynamic model for forecasting the same year (current year-order 0), F1 subsystem indicates that the subsystem array is suitable for constructing biomass dynamic model for forecasting the next year (next year, order 1), F2 subsystem indicates that the subsystem array is suitable for constructing biomass dynamic model for forecasting the next two years (the year after next, order 2), . . . and Fn subsystem indicates that the subsystem array is suitable for constructing biomass dynamic model for forecasting the next n years (the n-th year after the current year, order n). The purpose for setting the time-sharing subsystems is to facilitate users to construct the population dynamics model of different time periods in the future by using different factor group array, to meet the demands for forecasting in different time periods in the future; it is intended to solve the problem of how to predict the future development trends of populations under the condition of can not knowing the variables of future influencing factors.

The globally universal key factor preset array platform for dynamic forecast analysis of biological populations is abbreviated as UKF-PAP (Universal Key Factor Preset Array Platform) in examples in the invention.

### EXAMPLE 1

Construct Quantity Dynamic Model of a Variety of Global Natural Life Populations in Any Period of Time Within Years:

UKF-PAP number set of the UKF-PAP is a global common key factor group using the year as a time period, Thus, it can be used to construct numerical model of dynamic quantity of a variety of natural life populations in any regions of the world that can be measured in any period of time within years (such as birth rate, mortality rate, laws of prevalence of some human diseases, laws of prevalence of crop pests and rodents, dynamic prediction of global crop yields, annual occurrence dynamics of some small wild animals with more generations within one year, annual growth rate of some perennial wild plants, etc.). The “any period of time within years” means that, any one year can be divided into whole year, quarter, month, ten-day, and day, and any period easily divided by users. Users divide the period of time within the year depends entirely on the nature of dependent variables provided by users. For example: If a user provides annual birth rate for many years in a region, then the model result is the birth rate dynamics within the year; and if a user provides monthly average birth rate within the year, then the model result is the monthly average birth rate dynamics within the year; and if a user provides the birth rate of June within each year, then the model result is the birth rate dynamic of June within the year; and if a user provides the birth rate data using a quarter, a ten-day, a day within each year, then the model result is the birth rate dynamic of a quarter, a ten-day, a day within the year, and it is similar for other living bodies.

### EXAMPLE 2

Key Controlled Factors and Concomitant Factors Used to Screen Specific Life Objects:

Through statistical analysis on hundreds of cases with different countries, different regions, different species of living bodies, different historical years and different quantity of measured indices, the results show that, although there are hundred thousands of alternative UKF-PAP factors in UKF-PAP, for each specific natural living body, there are no more than 10 key controlled factors or concomitant factors at p≦0.05 statistically significant level, usually 2-6 factors. However, there are different controlled factors or concomitant factors for the same species in different living bodies or in different regions or period of time. With this finding, it is very convenient and feasible for users to analyze and screen the specific controlled factors and concomitant factors of each living body, or analyze the homogeneity and heterogeneity of key controlled factors and concomitant factors of different living bodies in the same region or the living bodies of the same species in different regions using UKF-PAP.

### EXAMPLE 3

Analyze the Common Dominant Factors of Major Living Bodies which Influence the Closely Related to Human Being in the Worldwide or Some Region.

The expressions of all mathematical models constructed by UKF-PAP are all visible, and in the forms, they are simple linear regression models which are well known by peoples. Among these regression models, each independent variable name is one-to-one corresponding to the name of UKF-PAP variable, so, each independent variable name represents a key influencing factor or its combination. Besides, in the list of regression coefficients of regression analysis results, another column can show the standardized regression coefficients, and each factor included in the regression model will correspond to a standard regression coefficient, the size of the standard regression coefficient represents the size of the impact of each selected factor. Users can get the percentage of relative effect of each factor only using a sample mathematics. If a user constructs models for a variety of living bodies, just statistical the relative size of selected factor in the selected frequency and standard regression coefficients of each model, to get the common dominant factors which had maximum influence on the quantity dynamics of living bodies within the year for the constructed models.

### EXAMPLE 4

Back Substitution Forecasting:

Back substitution forecasting is: After constructing model with a group of measured values of independent variables and corresponding measured values of dependent variables, substitute this group of values of independent variables to the constructed model, to calculate a group of new dependent variables, which is called back substitution predicted values. The difference significance between them can be tested by chi square method, usually when the judgment criteria is D≦χ²_{0.05-0.999}, it shows no significant difference between them, i.e. the predicted value and the measured value belong to the same population, and the forecast is valid; and the smaller the cumulative chi square value (D) between the predicted dependent variable and the measured dependent variable, the better prediction effect of the back substitution. If D≧χ²_{0.05}, it shows that there is significant difference between them, and the forecasting is invalid. For the forecasting effect of UKF-PAP, over 95% of the different cases can be achieved at D≦χ²_{0.05-0.99}, i.e. the forecasting effect of back substitution is excellent.

### EXAMPLE 5

Stochastic Forecasting:

Stochastic Forecasting is: After constructing model with a group of measured values of independent variables and corresponding measured values of dependent variables, substitute another group of independent variables that are not involved in the modeling process due to lack of corresponding dependent variables to the constructed model, to calculate a group of new dependent variables, which is called stochastic predicted values. Then chi square method is used to test the significance of the difference between the predicted values and the values of dependent variables which are corresponded to the independent variables that are not involved in the modeling process, usually when the judgment criteria is D≦χ²_{0.05-0.999}, it shows no significant difference between them, i.e. the predicted value and the measured value belong to the same population, and the forecast is valid. If D≧χ²_{0.05}, it shows that there is significant difference between them, and the forecasting is invalid, and the smaller the cumulative chi square value (D) between the predicted dependent variable and the measured dependent variable, the better the forecasting effect. For the forecasting effect of UKF-PAP, over 95% of the different cases can be achieved at D≦χ²_{0.05-0.99}, i.e. the forecasting effect is excellent. Stochastic forecasting can be widely used for theoretical forecasting of the value of the dependent variable when the independent variables are known but the dependent variables are unknown in the past, present or future.

### EXAMPLE 6

Future Forecasting:

Future forecasting means to forecast the things that have not happened using the things that have happened in the past and at present. Technical solutions in the invention: After constructing model with a group of measured values of dependent variables and the corresponding measured values of independent variables in the past many years, substitute another group of values of independent variable that not involved in the last part of the modeling process to the established model, to calculate a group of new dependent variables, which is called future predicted value, i.e. the independent variables which correspond to this group of future predicted values in time sequence are the variables of things happened in the past. Chi—square test method can be used to carry out fitness test of future predicted values, usually when the judgment criteria is D≦χ²_{0.05-0.999}, it shows no significant difference between them, i.e. the future predicted value and the measured value belong to the same population, and the forecast is valid; and the smaller the cumulative chi square value (D) between the future predicted dependent variable and the measured dependent variable, the better the future forecasting effect. If D≧χ²_{0.05}, it shows that there is significant difference between them, and the forecasting is invalid. For the future forecasting effect of UKF-PAP, over 95% of the different cases can be achieved at D≦χ²_{0.05-0.99}, i.e. the forecasting effect is excellent.

The present invention can achieve the following beneficial effects:
(1) In the past, when people perform forecasting analysis on biological populations, some predicted values are far from the measured values (i.e. Outlier of predicted values) in some models, which results in poor forecast effect.

When performing forecasting with the invention, users usually have two groups or more groups of effect forecast models for options, therefore, they can observe the case which is correspond to by the maximum χ² value in the fit results of predicted value and observation values of different models in the process of selecting the optimal equation, through χ² test; and if the maximum χ² value in the fit results of many groups of models all corresponds to the same observation result, it can be judged that the outlier is the wrong of observation, and it can be ruled out to re-construct a new model; and if outliers appear in an individual model, then it can be judged that the outlier is the wrong of the model, and another model should be selected.
(2) In the past, people tend to pay attention to the correlation of things in the same period and nearby, but ignore the correlation of things in the past and far away; therefore, it can result in the available environmental information difficult to meet information amount required by the forecast models.

When the present invention is applied to forecast, the preset factor array can provide enough environmental information that can not be obtained by users themselves within a short time, which can nearly completely satisfy the forecasting on any known natural life populations of user and users' forecasting requirements for environmental information; and at the same time, users can add their known environmental information to study together.
(3) In the past, single factor or a few factors are used to screen and construct models due to unable to find more environmental factors, thus ignore the more and higher relevant influencing factors, resulting in serious one-sidedness of the obtained forecast models. So that even if the simulation effect is better, because of the uncertainty of the forecast factor itself (for example, the influence is larger due to irregularity of other unknown factors), its forecast effect is not ideal for the predicted objects.

When the present invention is applied to forecast, the preset factor array has collected most conventional key factors which most have been known, relate to the life survival and death and has universal applicability at the existing stage over the world, and provided great conveniences for users to comparison and analysis the multiple forecast models constructed with the same predicted objects, which greatly reduces the risks of one-sided conclusions obtained from single factor or less factor analysis in local regions, and thus, it gives a guarantee for increasing the accuracy of the forecast results.

The foregoing is only preferred embodiments of the present invention, which is not intended to limit the invention. Any modifications, equivalent replacements and improvements made within the spirit and principles of the invention shall be included in the scope of protection of the present invention.

1. A globally universal key factor preset array platform for dynamic forecast analysis of biological populations, wherein each data is co-located by a row variable coordinate and a column variable coordinate, and each located individual datum can not be interchanged up and down or to and fro, the row variable coordinate is time coordinate and the column variable coordinate is space coordinate.

2. The globally universal key factor preset array platform for dynamic forecast analysis of biological populations according to claim 1, wherein the up-down sequence of a row variable coordinate is represented by a natural number or any one interval of time among year, quarter, month, ten-day, week or day, and the up-down sequence can not be interchanged up and down or to and fro.

3. The globally universal key factor preset array platform for dynamic forecast analysis of biological populations according to claim 1, wherein the name of column variable coordinate is represented by a natural number, an English letter, a combination of natural number and English letter, or original factor name of the column variable, and the left-right sequence of column variable can be interchanged in whole column with the name, but the position of a single data cannot be interchanged.

4. The globally universal key factor preset array platform for dynamic forecast analysis of biological populations according to claim 1, wherein it comprises a preset factor array and a user factor array; in the preset factor array, except the time sequence variable representing time coordinate, the sum and mean of this column array of variables in other each of column is 0, and both the standard deviation and variance are 1, the sum, mean, standard deviation and variance of the array in each column variable in the user factor array are not restricted by the numerical size and range, but determined by the actual valid array input by users.

5. The globally universal key factor preset array platform for dynamic forecast analysis of biological populations according to claim 4, wherein the number of rows of a row variable of the preset factor array in the platform is greater than or equal to 50 and less than or equal to ∞, the number of columns of a column variable of the preset factor array is greater than or equal to 50 and less than or equal to co, each data in the preset factor array and user factor array are not restricted by the numerical size, positive or negative number or signs.

6. The globally universal key factor preset array platform for dynamic forecast analysis of biological populations according to claim 4, wherein a dependent variable of user factor array in the platform is a forecasting object, the number of rows of the dependent variable is greater than or equal to 11, the number of columns is greater than or equal to 1; when the independent variable of user factor array is user-provided forecast factor, the number of rows of the independent is greater than or equal to 11, and the number of columns is greater than or equal to 0, when the number of columns is 0, it indicates that users do not provide user-provided forecast factor.

7. The globally universal key factor preset array platform for dynamic forecast analysis of biological populations according to claim 1, wherein it is integrally fixed, integrally publicly spread, integrally publicly used and integrally or partially updated through all modern electronic communication equipment, Internet media and all mobile and non-mobile electronic carriers.

8. The globally universal key factor preset array platform for dynamic forecast analysis of biological populations according to claim 1, wherein it is integrally installed in any electronic connected network platform, and integrally installed in all mathematical statistic analysis software, geographic information software, navigation software for operation and application.

9. The globally universal key factor preset array platform for dynamic forecast analysis of biological populations according to claim 1, wherein it is compiled into a separate operating system, produced into a separate hardware chip and mounted to all mobile and non-mobile electron carriers for fixing, public communication, public use, and updating in whole or in part, or made to wholly independent monomer or complex electronic devices that are dedicated to forecasting for spreading.

10. The globally universal key factor preset array platform for dynamic forecast analysis of biological populations according to claim 1, wherein it is compiled into independent electronic chips and produced into electronic equipment by cooperating with other similar industries technically;
the globally universal key factor preset array platform for dynamic forecast analysis of biological populations comprises a plurality of time-sharing subsystems, including F0 subsystem, F1 subsystem, F2 subsystem, . . . , Fn subsystem, and the serial number of each subsystem in the many subsystem represents the time stair serial number of the same serial number;
through the Internet user's registration system, global users for biological population dynamic forecast in various countries of the world can instantly select the contents and use the globally universal key factor preset array platform for dynamic forecast analysis of biological populations by payment.
